(19) United States
(12) Patent Application Publication
(10) Pub. No.: US 2025/0091945 A1
(43) Pub. Date: Mar. 20, 2025

(54) Coating Approach to Prevent Agglomeration of Spherical Lightweight Aggregate (LWA) During Sintering

(71) Applicant: Drexel University, Philadelphia, PA (US)

(72) Inventors: Mohammad Balapour, Phiadelphia, PA (US); Yaghoob Farnam, Philadelphia, PA (US)

(21) Appl. No.: 18/728,125

(22) PCT Filed: Jun. 30, 2022
(86) PCT No.: PCT/US2022/035719

§ 371 Date: Jul. 11, 2024

Related U.S. Application Data
(60) Provisional application No. 63/301,505, filed on Jan. 21, 2022.

(51) Int. Cl. C04B 18/02; C04B 18/08

(52) U.S. Cl. CPC C04B 18/027; C04B 18/08

(57) ABSTRACT

During lightweight aggregate (LWA) production through sintering process, formation of liquid phase captures emitted gas to form pores in the LWA and leads to successful bloating. As the LWA undergoes sintering in the kiln, the liquid phase starts to form on the LWA surface. Accordingly, in a rotary kiln where the LWA are continually rolling over each other, the touching surfaces of LWAs with liquid phase start to adhere together and form lumps of LWA exiting the furnace. This method prevents agglomeration of spherical LWA during sintering. The LWA can be produced from clay, slate, shale, and potentially other waste materials. This method results in production of discrete spherical LWA particles that can be coated with waste fly ash particles to form a thin layer on the surface of LWA that will not melt during sintering and will prevent touching surfaces of LWA particles from sticking together and forming lumps.

### CROSS-REFERENCE TO RELATED APPLICATION

The present application claims the benefit of U.S. Provisional Patent Application Ser. No. 63/301,505, filed on Jan. 21, 2022, which is incorporated herein by reference in its entirety.

### STATEMENT REGARDING FEDERALLY SPONSORED RESEARCH OR DEVELOPMENT

The invention was made with government support under Contract 1918838, awarded by the National Science Foundation. The government has certain rights in the invention.

### BACKGROUND OF THE INVENTION

### Field of the Invention

The invention relates to a method for preventing agglomeration of lightweight aggregate (“LWA”) during the sintering process.

### Description of the Related Art

LWA due to its porous nature usually possess a high absorption capacity. If the absorption capacity of the LWA is not accounted for during concrete mixture design and preparation, the workability of concrete could be diminished. Use of spherical LWA is one of the approaches that can improve the workability and accordingly pumpability of concrete at job site. However, production of spherical LWA requires an intensive process to prevent particle agglomeration during sintering process. In addition, controlling the agglomeration during sintering process at large scale prevents kiln obstruction and assures continuous LWA production. FIG. 1 shows agglomerated spherical LWA particles 50, 52, 54 that have formed big lumps of LWA coming out of a rotary kiln.

It would be beneficial to provide a method of controlling and reducing or eliminating the agglomeration during sintering and production of synthetic spherical waste coal ash based LWA.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a method of preventing agglomeration of spherical lightweight aggregate (LWA) during sintering. The method includes the steps of mixing an initial mass of waste-coal combustion ash with a fluxing agent; pelletizing the waste-coal combustion ash in a pelletizer; adding an additional 10%-15% by mass of the initial to the pelletizer, forming a LWA; drying the LWA formed above; and sintering the LWA in a rotary kiln.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 shows agglomerated spherical LWA particles that have formed big lumps of LWA coming out of a rotary kiln (Prior Art);

FIG. 2 is a schematic representation for production of spherical LWA with no agglomeration;

FIG. 3 shows the produced LWA through the inventive coating method;

FIG. 4A shows the microstructure of a spherical fresh LWA prepared with fly ash which is treated with fluxing agent;

FIG. 4B shows the microstructure of the spherical fresh LWA that is coated with dry fly ash particles (with no fluxing agent);

FIG. 4C shows the microstructure of the sintered spherical LWA that was coated with dry fly ash particles; and

FIG. 5 shows the micrograph of a spherical LWA coated with dry fly ash particles and sintered using a rotary kiln.

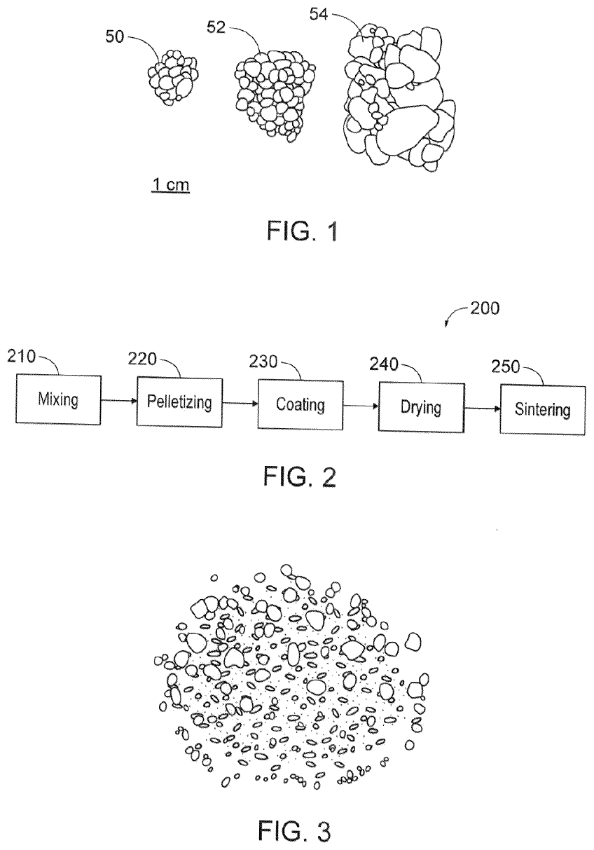

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The following provides a method for coating spherical Lightweight Aggregate (LWA) to prevent agglomeration during sintering.

FIG. 2 provides a flow chart 200 of an exemplary process to prepare and produce a LWA with non-adhesive surface during sintering that results in discrete spherical LWA particles without agglomeration. The details of the process includes:

In step 210, as-received calcium-silicate-aluminate waste materials (CSA), such as Waste-Coal Combustion Ash (W-CCA) (with known moisture content), is mixed with an appropriate amount of a fluxing agent using a blender. In an exemplary embodiment, the fluxing agent can be NaOH (sodium hydroxide). The required fluxing agent amount is described in PCT patent application PCT/US20/56976, which is incorporated herein by reference in its entirety.

In step 220, the CSA ash is pelletized using a pelletizer (not shown) tilted at 45-degree angle and about 20 rpm mixing speed until spherical fresh pellets are achieved.

In step 230, 10%-15% by mass (of initial CSA amount) raw dry fly ash (with no fluxing agent) is added to the pelletizer, two minutes before the end of step 220. The added dry fly ash will act as a coating material to cover the surface of moist fresh LWA. In general, any calcium-silicate-aluminate fine particle with a melting temperature above melting temperature of fresh pellet prepared in Step 220 can be used as a coating material.

In step 240, fresh CSA based LWA is dried at 110° C. for 3 hours (or higher temperature for shorter time) to provide the fresh pellets with enough strength required for handling and conveying to a rotary kiln (not shown). Different drying scenarios may be also applied.

In step 250, the LWA is sintered in the rotary kiln at predetermined temperature, kiln angle, and rotation speed to have an optimized mean residence time and achieve an optimized sintering for the LWA. The mean residence time can range from 30 min to 15 min, which can be achieved by a kiln angle of ranging from 2° to 4° and kiln rotation speed of about 3 rpm. The kiln temperature can range from about 1075° C. to 1200° C. The kiln temperature can also be identifice based on the PCT patent application PCT/US20/56976, which is incorporated herein by reference in its entirety.

FIG. 3 shows the produced LWA through the coating method of flowchart 200. As can be seen, no agglomeration was observed for the LWA that were discharged from the rotary kiln. Coating fresh pellet in Step 230 successfully prevents LWA agglomeration in the rotary kiln and preserves the spherical shape of the LWA.

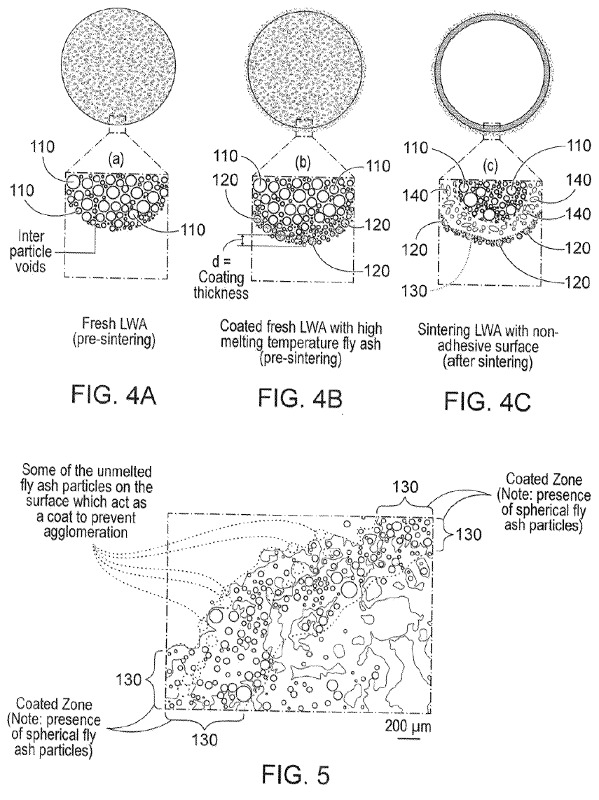

FIGS. 4A-4C schematically demonstrate the coating concept of the present invention. FIG. 4A shows the microstructure of a spherical fresh LWA 110 prepared with fly ash which is treated with fluxing agent.

FIG. 4B shows the microstructure of the spherical fresh LWA 110 that is coated with dry fly ash particles 120 (with no fluxing agent).

FIG. 4C shows the microstructure of the sintered spherical LWA 110 which was coated with dry fly ash particles 120. The presence of a coating zone 130 on the surface of LWA during sintering prevents touching surface from sticking together and resulting in agglomeration. Random shaped gas-filled pores 140 form in the non-adhesive coating zone 130. The coating zone 130 is indicated by the area between the two dashed lines.

FIG. 5 shows the micrograph of a spherical LWA coated with dry fly ash particles and sintered using a rotary kiln. As can be noted, many spherical fly ash particles are present in the coating zone 130 that has successfully resulted in development of a non-adhesive surface for agglomeration prevention during sintering.

It will be further understood that various changes in the details,

materials, and arrangements of the parts which have been described and illustrated in order to explain the nature of this invention may be made by those skilled in the art without departing from the scope of the invention as expressed in the following claims.

We claim:

1. A method of preventing agglomeration of lightweight aggregate (LWA) during sintering, the method comprising the steps of:
(a) mixing an initial mass of calcium-silicate-aluminate waste materials with a fluxing agent;
(b) pelletizing the waste materials in a pelletizer to form pellets;
(c) adding raw dry fly ash in an amount equal to 10%-15% by mass of the initial calcium-silicate-aluminate waste materials to the pelletizer, coating the pellets;
(d) drying the LWA formed in step (c); and
(e) sintering the LWA in a rotary kiln.

2. The method according to claim 1, wherein step (a) comprises providing the fluxing agent comprising NaOH (sodium hydroxide).

3. The method according to claim 1, wherein step (b) comprises tilting the pelletizer at an angle of about 45 degrees.

4. The method according to claim 1, wherein step (b) comprises operating the pelletizer at a mixing speed of 20.

5. The method according to claim 1, wherein step (b) produces spherical green pellets.

6. The method according to claim 1, wherein step (c) comprises adding the additional 10%-15% by mass of the initial waste materials two minutes before the end of step (b).

7. The method according to claim 6, wherein the additional raw dry ash comprises a material having a melting temperature above the melting temperature of the pellets prepared in step (b).

8. The method according to claim 1, wherein step (e) is performed with the kiln at a temperature of between about 1075° C. and about 1200° C.

9. The method according to claim 1, wherein step (e) is performed with the kiln tilted at an angle of 2° to 4°.

10. The method according to claim 1, wherein step (e) is performed with the kiln having a rotation speed of about 3 rpm.

11. The method according to claim 1, wherein step (e) forms a non-adhesive coating zone around the LWA.

12. The method according to claim 11, wherein step (e) forms random shaped gas-filled pores in the non-adhesive coating zone.

13. A lightweight aggregate formed by the method according to claim 1.

14. The aggregate according to claim 13, wherein the LWA is spherical.
